(19) United States
(12) Patent Application Publication
(10) Pub. No.: US 2017/0252913 A1
(43) Pub. Date: Sep. 7, 2017

(54) Combination Office Supply Tool

(71) Applicant: LaDale Bishop, JR., Hueytown, AL (US)

(72) Inventor: LaDale Bishop, JR., Hueytown, AL (US)

(21) Appl. No.: 15/448,864

(22) Filed: Mar. 3, 2017

Related U.S. Application Data
(60) Provisional application No. 62/303,457, filed on Mar. 4, 2016.

(51) Int. Cl. B25C 5/02; F21V 33/00; B43M 7/00; B43L 23/08; B25C 11/02; B65H 35/00

(52) U.S. Cl. CPC B25C 5/0214; B25C 11/02; B25C 5/025; B65H 35/0026; B43M 7/002; B43L 23/08; F21V 33/0048; F21V 23/04

(57) ABSTRACT

A combination office supply tool includes an upper member hingedly attached to a lower member, a staple portion located in the upper member, and a hole punch portion including a hole punch extension located on a lower surface of the upper member and projecting towards the lower member. The staple portion includes a staple dispenser for discharging staples towards the lower member and a staple track for urging staples towards the staple dispenser. The hole punch portion includes a hole punch base attached to an upper surface of the lower member for receiving the hole punch extension within an aperture of the hole punch base.

### CROSS-REFERENCE TO RELATED APPLICATION

This application claims priority to U.S. Provisional Patent Application No. 62/303,457 filed on Mar. 4, 2016 to LaDale Bishop Jr. and titled “7-in-1 Office Pro”, the contents of which are incorporated herein by reference in its entirety.

### FIELD

This disclosure relates to the field of office tools. More particularly, this disclosure relates to an office tool that provides multiple office tools within a single device.

### BACKGROUND

Many individuals utilize office supplies throughout the day to complete various tasks. Office supplies and tools such as staplers, pencil sharpeners, letter openers, hole punches, and other similar tools are often left on a table or desktop, thereby creating clutter. Individuals are often required to purchase multiple tools when undertaking office work.

Various devices exist related to providing multiple tools. For example, some tools provide combinations of a hole punch and a stapler. Other examples include additional combinations of functions such as providing staplers, tape dispensers, box cutters, markers, etc. However, these devices do not efficiently combine these various tools into a single package usable in an office environment.

What is needed, therefore, is a combination office supply tool that combines to provide various needed office tools.

### SUMMARY

The above and other needs are met by a combination office supply tool that combines various office tools into a single device. In a first aspect, a combination office supply tool including: an upper member hingedly attached to a lower member; a staple portion located in the upper member, the staple portion including a staple dispenser formed in a distal end of the upper member for discharging staples from the upper member towards the lower member and a staple track formed within the upper member adjacent to the staple dispenser, the staple track including a spring and staple follower slidable along the staple track for urging staples towards the staple dispenser; a first light portion positioned within the upper member at the distal end of the upper member adjacent to the staple dispenser of the staple portion; a tape roll rotatably mounted to the upper member, the tape roll accessible through an aperture formed on an upper surface of the upper member; and a hole punch portion including a hole punch extension located on a lower surface of the upper member and projecting towards the lower member and a hole punch base attached to an upper surface of the lower member for receiving the hole punch extension within an aperture of the hole punch base.

In one embodiment, the staple portion, tape roll, and hole punch extension are located on a staple frame, the staple frame pivotable with respect to the upper member and lower member.

In another embodiment, the upper member further includes a hole puncher lock slidably engaged with the staple frame to prevent the staple frame from pivoting with respect to the upper member, thereby enabling the hole punch extension to engage the hole punch base without dispensing a staple from the staple portion. In yet another embodiment, the combination office supply tool further includes a serrated tape cutter located on the upper member.

In one embodiment, the combination office supply tool further includes a second light portion within the upper member for emitting light through a light aperture formed along an upper surface of the upper member.

In another embodiment, the combination office supply tool further includes a letter opener formed in the lower member, the letter opener including a sharpened edge and a cavity adjacent the sharpened edge.

In yet another embodiment, the combination office supply tool further includes a staple remover removably inserted into a pocket formed in the lower member of the combination office supply tool. In one embodiment, the combination office supply tool further includes a pencil sharpener portion formed in an end of the lower member.

In another embodiment, the combination office supply tool further includes a foot portion removably attached to a body portion of the lower member. In yet another embodiment, a space is formed between the foot portion and body portion of the lower member for receiving shavings from the pencil sharpener portion.

In a second aspect, a combination office supply tool is provided including: an upper member hingedly attached to a lower member; a staple portion located in the upper member, the staple portion including a staple dispenser formed in a distal end of the upper member for discharging staples from the upper member towards the lower member and a staple track formed within the upper member adjacent to the staple dispenser, the staple track including a spring and staple follower slidable along the staple track for urging staples towards the staple dispenser; a first light portion positioned within the upper member at the distal end of the upper member adjacent to the staple dispenser of the staple portion; a tape roll rotatably mounted to the upper member, the tape roll accessible through an aperture formed on an upper surface of the upper member a serrated tape cutter located on the upper member adjacent to the tape roll; and a hole punch portion including a hole punch extension located on a lower surface of the upper member and projecting towards the lower member and a hole punch base attached to an upper surface of the lower member for receiving the hole punch extension within an aperture of the hole punch base.

In one embodiment, the staple portion, tape roll, and hole punch extension are located on a staple frame, the staple frame pivotable with respect to the upper member and lower member. In another embodiment, the combination office supply tool further includes a pencil sharpener portion formed in an end of the lower member.

In a third aspect, a combination office supply tool is provided including: an upper member hingedly attached to a lower member; a staple portion located in the upper member, the staple portion including a staple dispenser formed in a distal end of the upper member for discharging staples from the upper member towards the lower member and a staple track formed within the upper member adjacent to the staple dispenser, the staple track including a spring and staple follower slidable along the staple track for urging staples towards the staple dispenser; a first light portion positioned within the upper member at the distal end of the upper member adjacent to the staple dispenser of the staple portion; a tape roll rotatably mounted to the upper member, the tape roll accessible through an aperture formed on an upper surface of the upper member a serrated tape cutter located on the upper member adjacent to the tape roll; a hole punch portion including a hole punch extension located on a lower surface of the upper member and projecting towards the lower member and a hole punch base attached to an upper surface of the lower member for receiving the hole punch extension within an aperture of the hole punch base; and a pencil sharpener portion formed in an end of the lower member; wherein the staple portion, tape roll, and hole punch extension are located on a staple frame, the staple frame pivotable with respect to the upper member and lower member.

### BRIEF DESCRIPTION OF THE DRAWINGS

Further features, aspects, and advantages of the present disclosure will become better understood by reference to the following detailed description, appended claims, and accompanying figures, wherein elements are not to scale so as to more clearly show the details, wherein like reference numbers indicate like elements throughout the several views, and wherein:

FIGS. 1 and 2 show perspective views of a combination office supply tool according to one embodiment of the present disclosure;

FIG. 3 shows a combination office supply tool according to one embodiment of the present disclosure;

FIG. 4 shows an exploded view of a combination office supply tool according to one embodiment of the present disclosure;

FIG. 5 shows an exploded side view of a combination office supply tool according to one embodiment of the present disclosure;

FIG. 6 shows a side view of a combination office supply tool according to one embodiment of the present disclosure;

FIG. 7 shows a perspective view of an upper member of a combination office supply tool according to one embodiment of the present disclosure;

FIG. 8 shows a perspective view of a staple frame of a combination office supply tool according to one embodiment of the present disclosure;

FIG. 9 shows a lower member of a combination office supply tool according to one embodiment of the present disclosure; and

FIG. 10 shows an exploded rear view of a combination office supply tool according to one embodiment of the present disclosure.

### DETAILED DESCRIPTION

Various terms used herein are intended to have particular meanings. Some of these terms are defined below for the purpose of clarity. The definitions given below are meant to cover all forms of the words being defined (e.g., singular, plural, present tense, past tense). If the definition of any term below diverges from the commonly understood and/or dictionary definition of such term, the definitions below control.

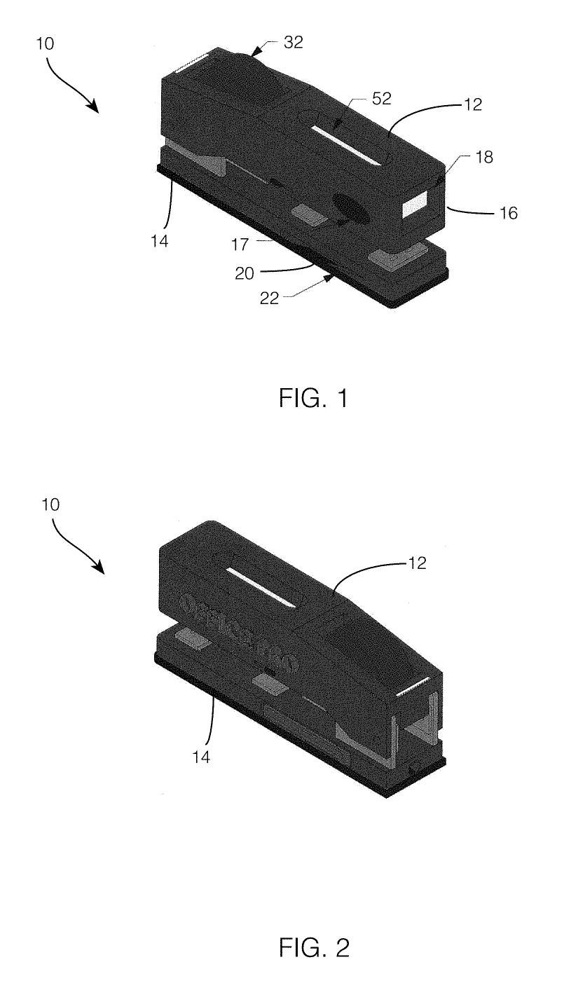

Referring to FIGS. 1 and 2, a perspective view of a multifunction office tool 10 according to the present disclosure is shown. The multifunction office tool 10 generally comprises an upper member 12 hingedly attached to a lower member 14. Staples are stored in the upper member 12 and are fed along a track to a stapling mechanism disposed on a front end thereof. A front facing end 16 of the upper member 12 has a first light portion 18 (including first light switch 17 for activating the first light portion 18 and an optional second light 52), such as a flashlight, disposed thereon for illuminating a user's workspace.

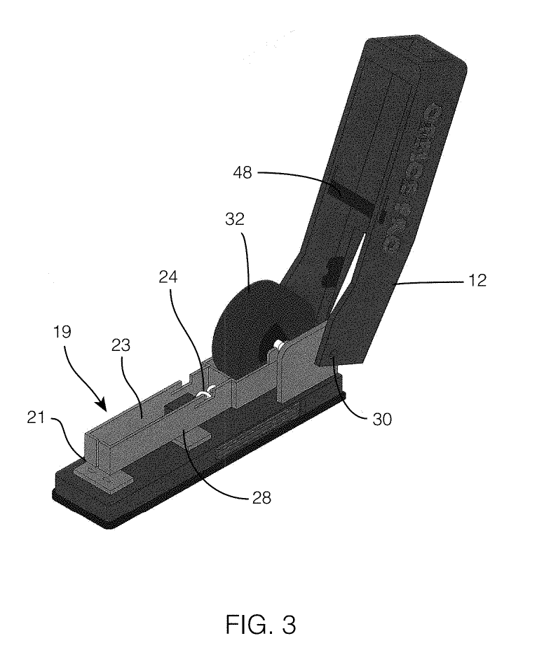

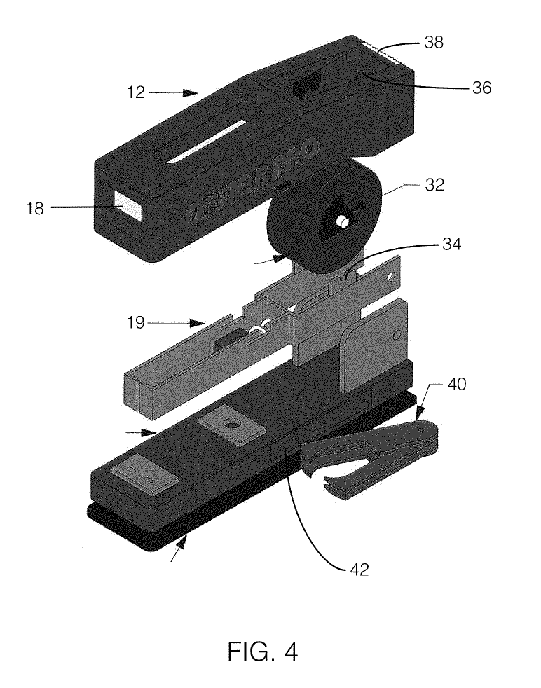

The upper member 12 includes a staple portion 19 (FIG. 3) formed therein for ejecting staples or other fasteners from the multifunction office tool 10. The staple portion 19 includes a staple dispenser 21 located at a distal end of the upper member 12 for discharging staples from the upper member 12 towards the lower member 14. A staple track 23 is formed on the staple portion 19 for storing a plurality of staples or other fasteners and includes a spring 24 and a staple follower 26 for urging staples within the staple track 23 towards the staple dispenser 21. As shown in FIG. 3, the staple dispenser 21 and staple track 23 are formed on a staple frame 28 that is joined with the upper member 12 by way of a hinge 30. The staple portion 19 may function as a traditional stapler in that when a user presses on the upper member 12, the staple frame 28 contacts the lower member 14 or a piece of paper between the upper member 12 and lower member 14, and wherein the upper member 12 further pivots with respect to the staple frame 28 and lower member 14 to urge a staple out of the staple dispenser 21.

The upper member 12 preferably includes both the first light portion 18 projecting from an end of the upper frame member and the second light 52 located along a length of an upper surface of the upper member 12. The light switch 17 may activate one or both of the first light portion 18 and second light 52. For example, the user may depress the switch 17 once to activate the first light portion 18, twice to activate the second light portion 52, and a third time to activate both the first light portion 18 and the second light portion 52.

A tape roll 32 is rotatably supported on the staple frame 28 of the upper member 12, such as with cradle 34. A tape aperture 36 is formed through an upper surface of the upper member 12 such that at least a portion of the tape roll 32 is accessible by a user through a top of the multifunction office tool 10. A serrated tape cutter 38 is preferably attached to the upper member 12 adjacent to the tape aperture 36 such that a piece of tape from the tape roll 32 may be cut at a desired length by a user.

The lower member 14 includes a recessed portion 20 (FIG. 1) configured to form a letter opener 22 therein. A staple remover 40 is located in a cavity 42 on a side of the lower member 14 opposing the letter opener 22.

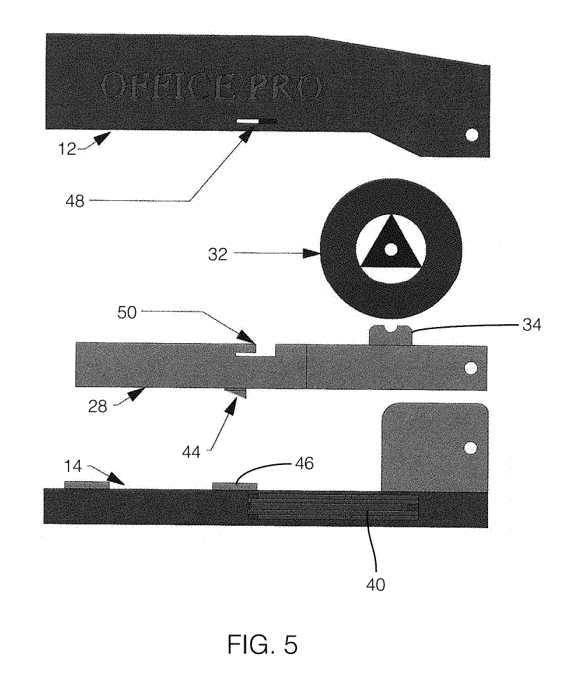

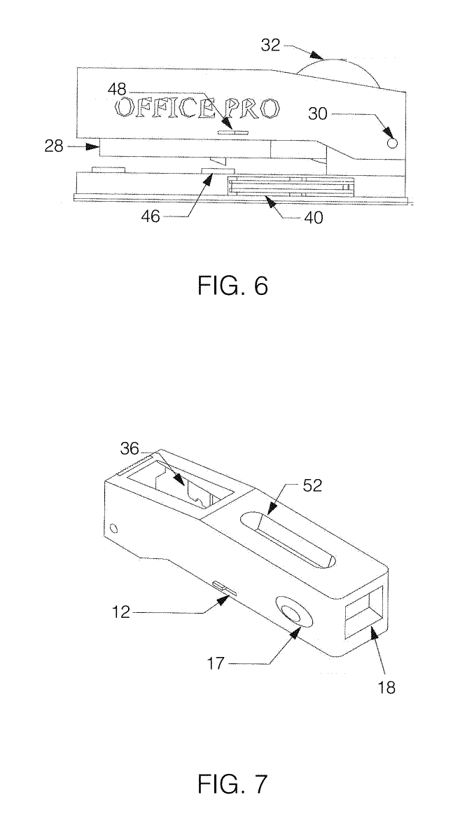

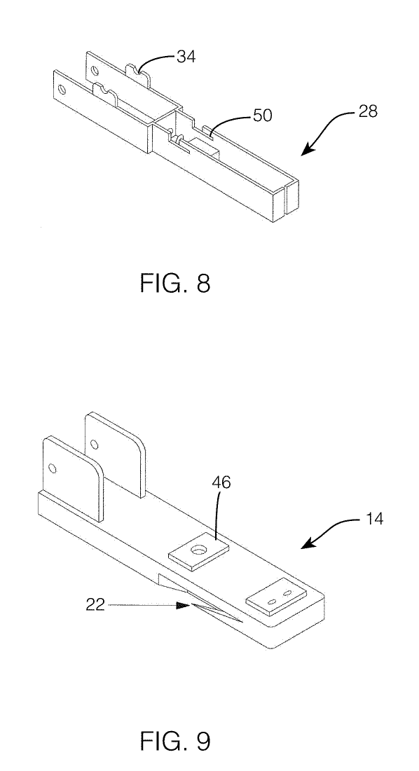

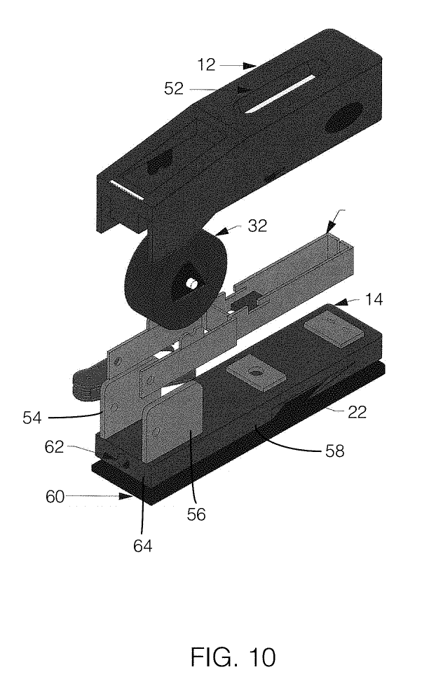

Referring now to FIG. 5, the multi-function office tool 10 further includes a hole punch portion for punching holes in one or more sheets of paper. The hole punch portion includes a hole punch extension 44 extending downward from a bottom surface of the staple frame 28 of the upper member 12 and towards the lower member 14. The lower member 14 includes a hole punch base 46 formed on an upper surface of the lower member 14 and aligned with the hole punch extension 44 on the upper member 12. The multi-function office tool 10 further includes a hole punch lock assembly including a sliding latch 48 and a slot 50 formed in the staple frame shaped to engage the sliding latch 48.

Referring to FIG. 10, the lower member 14 includes a pair of uprights 54 and 56 for engaging the upper member 12. The lower member 14 may include a body portion 58 and a rubber foot portion 60 attached to the body portion 58. The foot portion 60 may be formed of a flexible elastomer or rubber such that the lower member 14 grips a surface, such as a desk, and is easily removable from the body portion 58. The lower member 14 may further include a pencil sharpener portion 62 formed on an end 64 of the lower member 14. The pencil sharpener portion 62 receives a pencil into the pencil sharpener portion 62 such that when a user rotates the pencil a tip of the pencil becomes sharpened by the pencil sharpener portion 62. A space between the body portion 58 and foot portion 60 of the lower member 14 is in communication with the pencil sharpener portion 62 and the hole punch base 46 such that any scrap paper or pencil shavings are collected between the body portion 58 and foot portion 60.

During operation of the hole punch portion, a user may place a sheet of paper between the upper member 12 and lower member 14 and align the hole punch extension 44 and hole punch base 46 with a location at which the user desires to make a hole in the paper. Before pressing down on the upper member 12 to form a hole, the user first engages the sliding latch 48 with the slot 50. The sliding latch 48 is inserted into the slot 50 such that when a user presses on the upper member 12, the stapler frame 28 remains stationary relative to the upper member 12, thereby transferring any force of the user on the upper member through the hole punch extension 44 and towards the hole punch base 46. The sliding latch 48 and slot 50 prevent activation of the stapler portion when a user is attempting to utilize the hole punch portion of the multi-function office tool 10.

The foregoing description of preferred embodiments of the present disclosure has been presented for purposes of illustration and description. The described preferred embodiments are not intended to be exhaustive or to limit the scope of the disclosure to the precise form(s) disclosed. Obvious modifications or variations are possible in light of the above teachings. The embodiments are chosen and described in an effort to provide the best illustrations of the principles of the disclosure and its practical application, and to thereby enable one of ordinary skill in the art to utilize the concepts revealed in the disclosure in various embodiments and with various modifications as are suited to the particular use contemplated. All such modifications and variations are within the scope of the disclosure as determined by the appended claims when interpreted in accordance with the breadth to which they are fairly, legally, and equitably entitled.

What is claimed is:

1. A combination office supply tool comprising:
an upper member hingedly attached to a lower member;
a staple portion located in the upper member, the staple portion including
a staple dispenser formed in a distal end of the upper member for discharging staples from the upper member towards the lower member and
a staple track formed within the upper member adjacent to the staple dispenser, the staple track including a spring and staple follower slidable along the staple track for urging staples towards the staple dispenser;
a first light portion positioned within the upper member at the distal end of the upper member adjacent to the staple dispenser of the staple portion;
a tape roll rotatably mounted to the upper member, the tape roll accessible through an aperture formed on an upper surface of the upper member; and
a hole punch portion including a hole punch extension located on a lower surface of the upper member and projecting towards the lower member and a hole punch base attached to an upper surface of the lower member for receiving the hole punch extension within an aperture of the hole punch base.

2. The combination office supply tool of claim 1, wherein the staple portion, tape roll, and hole punch extension are located on a staple frame, the staple frame pivotable with respect to the upper member and lower member.

3. The combination office supply tool of claim 2, the upper member further comprising a hole puncher lock slidably engaged with the staple frame to prevent the staple frame from pivoting with respect to the upper member, thereby enabling the hole punch extension to engage the hole punch base without dispensing a staple from the staple portion.

4. The combination office supply tool of claim 1, further comprising a serrated tape cutter located on the upper member.

5. The combination office supply tool of claim 1, further comprising a second light portion within the upper member for emitting light through a light aperture formed along an upper surface of the upper member.

6. The combination office supply tool of claim 1, further comprising a letter opener formed in the lower member, the letter opener including a sharpened edge and a cavity adjacent the sharpened edge.

7. The combination office supply tool of claim 1, further comprising a staple remover removably inserted into a pocket formed in the lower member of the combination office supply tool.

8. The combination office supply tool of claim 1, further comprising a pencil sharpener portion formed in an end of the lower member.

9. The combination office supply tool of claim 8, the lower member further comprising a foot portion removably attached to a body portion of the lower member.

10. The combination office supply tool of claim 9, wherein a space is formed between the foot portion and body portion of the lower member for receiving shavings from the pencil sharpener portion.

11. A combination office supply tool comprising:
an upper member hingedly attached to a lower member;
a staple portion located in the upper member, the staple portion including
a staple dispenser formed in a distal end of the upper member for discharging staples from the upper member towards the lower member and
a staple track formed within the upper member adjacent to the staple dispenser, the staple track including a spring and staple follower slidable along the staple track for urging staples towards the staple dispenser;
a first light portion positioned within the upper member at the distal end of the upper member adjacent to the staple dispenser of the staple portion;
a tape roll rotatably mounted to the upper member, the tape roll accessible through an aperture formed on an upper surface of the upper member
a serrated tape cutter located on the upper member adjacent to the tape roll; and
a hole punch portion including a hole punch extension located on a lower surface of the upper member and projecting towards the lower member and a hole punch base attached to an upper surface of the lower member for receiving the hole punch extension within an aperture of the hole punch base.

12. The combination office supply tool of claim 11, wherein the staple portion, tape roll, and hole punch extension are located on a staple frame, the staple frame pivotable with respect to the upper member and lower member.

13. The combination office supply tool of claim 11, further comprising a pencil sharpener portion formed in an end of the lower member.

14. A combination office supply tool comprising:
an upper member hingedly attached to a lower member;
a staple portion located in the upper member, the staple portion including
a staple dispenser formed in a distal end of the upper member for discharging staples from the upper member towards the lower member and
a staple track formed within the upper member adjacent to the staple dispenser, the staple track including a spring and staple follower slidable along the staple track for urging staples towards the staple dispenser;
a first light portion positioned within the upper member at the distal end of the upper member adjacent to the staple dispenser of the staple portion;
a tape roll rotatably mounted to the upper member, the tape roll accessible through an aperture formed on an upper surface of the upper member
a serrated tape cutter located on the upper member adjacent to the tape roll;
a hole punch portion including a hole punch extension located on a lower surface of the upper member and projecting towards the lower member and a hole punch base attached to an upper surface of the lower member for receiving the hole punch extension within an aperture of the hole punch base; and
a pencil sharpener portion formed in an end of the lower member;
wherein the staple portion, tape roll, and hole punch extension are located on a staple frame, the staple frame pivotable with respect to the upper member and lower member.
